(19) United States
(12) Patent Application Publication
(10) Pub. No.: US 2018/0177003 A1
(43) Pub. Date: Jun. 21, 2018

(54) HIGH-FREQUENCY DIELECTRIC HEATING METHOD

(71) Applicant: TOYO SEIKAN GROUP HOLDINGS, LTD., Tokyo (JP)

(72) Inventors: Tomoki Maruyama, Yokohama-shi (JP); Shinji Yamada, Yokohama-shi (JP)

(73) Assignee: TOYO SEIKAN GROUP HOLDINGS, LTD., Tokyo (JP)

(21) Appl. No.: 15/895,298

(22) Filed: Feb. 13, 2018

Related U.S. Application Data
(63) Continuation of application No. PCT/JP2016/068974, filed on Jun. 27, 2016.

(30) Foreign Application Priority Data
Aug. 28, 2015 (JP) 2015-169430
Feb. 24, 2016 (JP) 2016-033527

(51) Int. Cl. H05B 6/62; H05B 6/54

(52) U.S. Cl. CPC H05B 6/62; H05B 6/54

(57) ABSTRACT

A high-frequency dielectric heating method in which an object to be heated is disposed between opposing electrodes and is heated, which is capable of suppressing a local temperature rise on opposing surfaces of the plurality of objects to be heated without reducing heating speed, and heating the plurality of objects to be heated in a short time. The method, in which an object to be heated (M) is disposed between opposing electrodes (101) and (102) and is heated, includes: disposing a plurality of the objects (M) in a direction in which the electrodes (101) and (102) oppose each other; and heating the plurality of the objects (M) in a state in which the plurality of the objects (M) are spaced apart by a predetermined distance or more by interposing a sheet member (110) between the plurality of the objects (M).

### TECHNICAL FIELD

The present invention relates to a high-frequency dielectric heating method in which an object to be heated is disposed between opposing electrodes and is heated, and particularly relates to a high-frequency dielectric heating method suitable for quick thawing of frozen food.

### BACKGROUND ART

Conventionally, in thawing of frozen food by high-frequency dielectric heating in which an object to be heated is disposed between opposing electrodes and is heated, due to the structure of the electrode for the high-frequency dielectric heating, there are cases where an air gap is formed by irregularities of the surface of the frozen food to be heated, electric fields are partially concentrated, and thawing unevenness occurs, and it is technically required to suppress the partial electric field concentration on the surface of the frozen food to thaw the frozen food evenly.

In order to alleviate such a problem, the applicant has proposed a technique in which an assembly of a plurality of pin electrodes including conductive pins is used as the electrode, the pin electrodes are made capable of moving independently of each other, the air gap is eliminated by causing the pin electrodes to come into contact with the surface of the frozen food to be heated so as to conform to the irregularities of the surface thereof, and it is thereby possible to suppress locally concentrated heating and thaw the frozen food evenly in a short time (see Patent Literature 1).

With the technique described in Patent Literature 1, the entire frozen food is evenly heated, and hence it becomes possible to complete the thawing in a short time by increasing an output.

### CITATION LIST

### Patent Literature

Patent Literature 1: Japanese Patent Application Publication No. 2010-267401

### SUMMARY OF INVENTION

### Technical Problem

In the case where the object to be heated is thin as compared with an interval between the electrodes, there is a need for disposing a plurality of the objects to be heated so as to stack them in a direction in which the electrodes oppose each other and heating a large number of the objects to be heated in a short time.

In doing so, it is possible to suppress the locally concentrated heating on the surfaces on the electrode side by using the pin electrodes described in Patent Literature 1 or other known means, but a problem arises in that a contact portion and the air gap are formed by the irregularities of the objects to be heated on opposing surfaces that are disposed so as to be stacked, and temperature unevenness occurs on the surfaces on the opposing side due to a difference in heating speed.

Further, in the case where the object to be heated such as the frozen food is thawed by heating, there are cases where a drip occurs during the thawing. When the drip flows out to the opposing surfaces of the objects to be heated that are disposed so as to be stacked, due to the high dielectric constant of water, a problem arises in that the dielectric constant changes according to a wet state of the object to be heated, and a local temperature rise becomes more conspicuous particularly at a portion where the drip collects.

For example, as shown in FIG. 6, when two frozen objects to be heated M are disposed so as to be directly stacked between a lower electrode 101 and an upper electrode 102 of a high-frequency dielectric heating device 100, and the objects to be heated M are heated and thawed by applying a high-frequency wave by a high-frequency power source 103, the opposing surfaces of the two objects to be heated have irregularities, and hence the contact portions and the air gaps are formed.

At this point, impedance is high at a portion where the air gap is formed and a gap is large because the dielectric constant of air is low, and impedance is relatively low at the contact portion, and hence a current is concentrated on the contact portion.

At the portion where the current is concentrated, the amount of heat generation is large, and hence thawing progresses quickly. However, the dielectric constant rises in the thawed frozen food material, and hence a further reduction in impedance and the current concentration are accelerated at the contact portion. With this, the contact portion exhibits thermal runaway, which leads to a reduction in quality such as the occurrence of discoloration or boiling. In addition, the current is reduced at portions other than the contact portion, and hence the thawing does not progress and the thawing becomes more uneven.

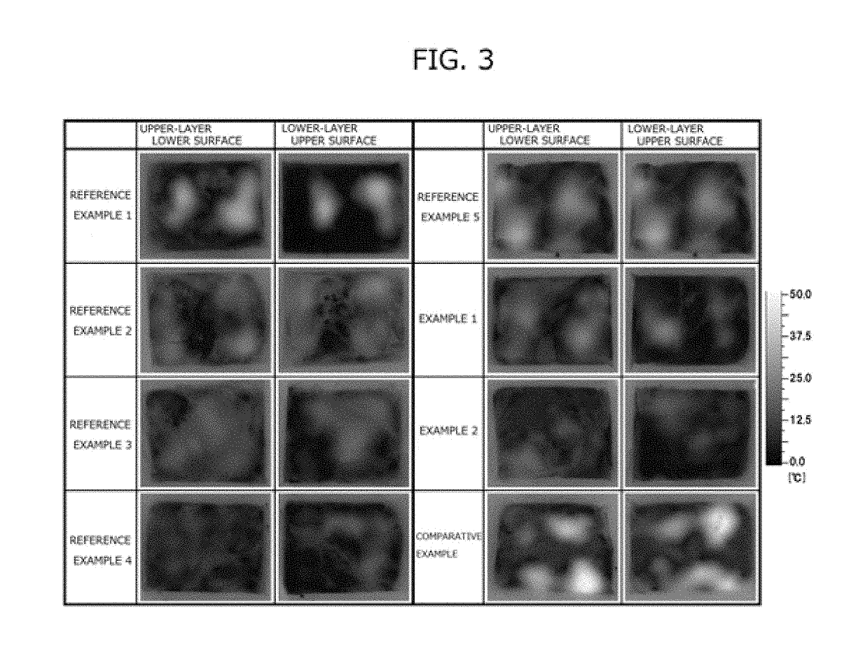

As in Comparative Example described later, when two packs of 2 kg of chicken leg meat having a pre-thawing temperature of −20° C. were stacked in two layers as samples and heated for 60 minutes with a high frequency of 13.56 MHz and an output of 500 VA, and the surface temperatures of the opposing surfaces ware observed, as shown in FIG. 3, a local temperature rise exceeding 50° C. occurred in the vicinity of the contact portion, and the occurrence of the boiling was observed in visual observation.

In addition, portions other than the portion where the local temperature rise occurred were not thawed adequately, and the thawed state thereof was an extremely uneven thawed state.

In the case where thawed food is refrigerated for a specific period of time after thawing, the temperature is locally increased to be significantly higher than a refrigeration temperature due to the local temperature rise, and hence the local temperature rise presents a problem in terms of quality preservation.

In addition, there is a possibility that composition change of protein or glucide and change such as melt of fat are caused by the local temperature rise, and hence a problem arises in that the high-frequency dielectric heating method cannot be used for food materials and foods that are served without being cooked, causes unevenness in cooking in the case where the food materials and the foods are cooked before being served, and adversely affects taste and texture.

In order to suppress the local significant temperature rise, it is necessary to make the temperature of the entire object to be heated even through thermal conduction in the object to be heated by reducing the heating speed.

The present invention solves the above problems, and an object thereof is to provide the high-frequency dielectric heating method capable of, when a plurality of the objects to be heated are disposed in the direction in which the electrodes oppose each other, suppressing the local temperature rise on the opposing surfaces of the objects to be heated without reducing the heating speed, and heating the plurality of the objects to be heated in a short time.

### Solution to Problem

A high-frequency dielectric heating method according to the present invention is a high-frequency dielectric heating method in which an object to be heated is disposed between opposing electrodes and is heated, the method including: disposing a plurality of the objects to be heated in a direction in which the electrodes oppose each other; and heating the plurality of the objects to be heated in a state in which the plurality of the objects to be heated are spaced apart by a predetermined distance or more, whereby the above problems are solved.

### Advantageous Effects of Invention

According to the high-frequency dielectric heating method of claim 1, it is possible to eliminate a contact portion between opposing surfaces of the opposing objects to be heated by heating the plurality of the objects to be heated in the state in which the plurality of the objects to be heated are spaced apart by the predetermined distance or more, and hence a difference in impedance that occurs depending on a location is reduced in the entire opposing surfaces, and concentration of a current is suppressed.

A method for spacing the plurality of the objects to be heated apart by the predetermined distance or more includes a method in which partitions similar to fences are provided at intervals larger than the thickness of the object to be heated between the electrodes and the objects to be heated are arranged, and a method in which the objects to be heated are accommodated in box-like containers and the containers are stacked in the direction in which the electrodes oppose each other.

With this, it is possible to suppress a local temperature rise on the opposing surfaces of the objects to be heated, and heat the plurality of the objects to be heated in a short time without reducing heating speed in order to achieve evenness through thermal conduction.

According to the high-frequency dielectric heating method of claim 2, it is possible to eliminate the contact portion between the opposing surfaces of the opposing objects to be heated by heating the plurality of the objects to be heated in a state in which the plurality of the objects to be heated are spaced apart by the predetermined distance or more by interposing a sheet member between the plurality of the objects to be heated, and hence the difference in impedance that occurs depending on the location is reduced in the entire opposing surfaces, and the concentration of the current is suppressed.

In addition, it is only necessary to sandwich the sheet member between the objects to be heated or wrap one of the opposing objects to be heated in the sheet member, and hence it is possible to space the objects to be heated apart at a predetermined interval even in the case where the objects to be heated are different in thickness, it is possible to use conventional devices and power sources without modifying them, and handling is easy.

According to a configuration of claim 3, the sheet member has a layer having a void inside the layer, whereby the dielectric constant of the sheet member is reduced, and hence the difference in impedance that occurs depending on the location is reduced in the entire opposing surfaces even when the thin sheet member is used, the concentration of the current is suppressed, and it is possible to suppress the local temperature rise on the opposing surfaces of the objects to be heated.

According to a configuration of claim 4, the sheet member has a liquid blocking function, whereby, even in the case where liquid such as a drip has occurred, an increase in dielectric constant caused by continuous presence of the liquid between the opposing surfaces of the objects to be heated is prevented, and it is possible to suppress the local temperature rise on the opposing surfaces of the objects to be heated further reliably.

According to a configuration of claim 5, the sheet member has a liquid absorption function, whereby, even in the case where the liquid such as the drip has occurred, the liquid is kept from wetting the surface of the object to be heated and spreading or flowing into a concave portion and collecting, the increase in dielectric constant is prevented, and it is possible to suppress the local temperature rise on the opposing surfaces of the objects to be heated further reliably.

According to a configuration of claim 6, the sheet member has at least a liquid absorption function layer and a liquid blocking function layer, whereby, when the liquid absorption function layer is positioned in an upper portion, the liquid such as the drip having flowed out from the upper object to be heated is absorbed and retained by the liquid absorption function layer, and the liquid blocking function layer does not allow the liquid to reach the surface of the lower object to be heated.

With this, the liquid is kept from wetting the surface of the object to be heated and spreading or flowing into the concave portion and collecting. Further, the liquid absorption function layer absorbs the liquid, the increase in dielectric constant caused by the continuous presence of the liquid between the opposing surfaces of the objects to be heated is thereby prevented, and it is possible to suppress the local temperature rise on the opposing surfaces of the objects to be heated reliably.

According to a configuration of claim 7, the sheet member has a liquid passage function layer on a surface on a side of the liquid absorption function layer, whereby, when the liquid passage function layer is positioned in an upper portion, the liquid such as the drip having flowed out from the upper object to be heated passes through the liquid passage function layer and is absorbed and retained by the liquid absorption function layer, and the liquid blocking function layer does not allow the liquid to reach the surface of the lower object to be heated.

With this, the liquid is kept from collecting on each of the surfaces of both of the opposing objects to be heated, the increase in dielectric constant is prevented, and it is possible to suppress the local temperature rise on the opposing surfaces of the objects to be heated reliably.

According to a configuration of claim 8, the liquid blocking function layer in the sheet member does not allow passage of liquid therethrough and has a cell inside the liquid blocking function layer, whereby it is possible to impart thermal insulation properties while maintaining the liquid blocking function. With this, even in the case where the local temperature rise has occurred on the surface of one of the opposing objects to be heated due to exposure of fat or bone that easily generates heat on the surface of the object to be heated or adhesion of a foreign substance to the surface thereof, it is possible to keep the local temperature rise from affecting the surface of the other object to be heated.

In addition, even in the case where the liquid absorbed and retained by the liquid absorption function layer has generated heat, it is possible to keep the heat from affecting the surface of the object to be heated.

According to a configuration of claim 9, the sheet member has flexibility, whereby, even in the case where irregularities of the surface of the object to be heated are large, the sheet member conforms to the irregularities of the surface of the object to be heated, the objects to be heated are thereby kept from being spaced apart by a distance larger than the thickness of the sheet member as compared with the case where the opposing objects to be heated are directly stacked, and it is possible to prevent heating efficiency from deteriorating.

In addition, even when the irregularities of the surface of the object to be heated are deformed during heating, the sheet member is also deformed correspondingly, and hence it is possible to maintain the same heating efficiency as that in the case where the opposing objects to be heated are directly stacked.

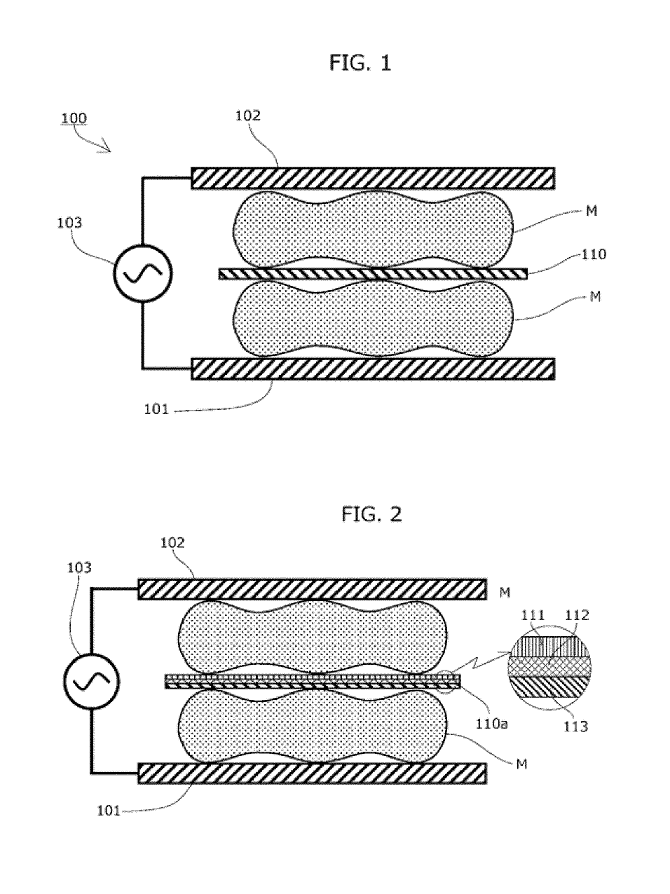

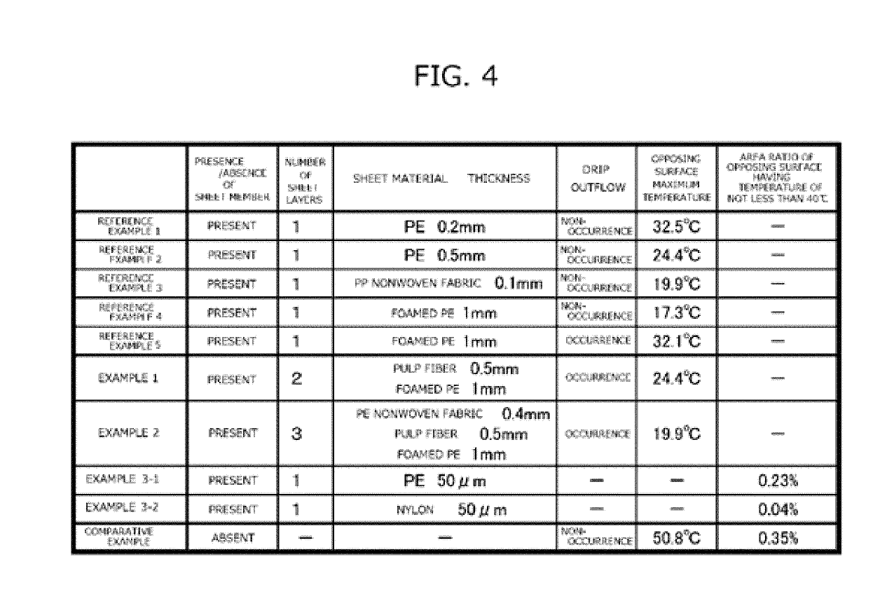

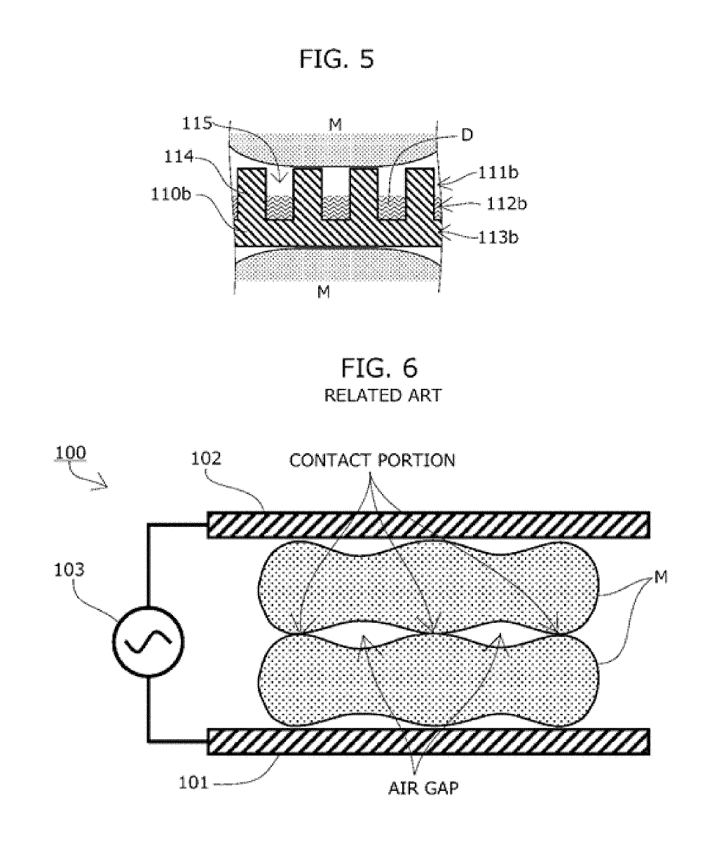

### BRIEF DESCRIPTION OF DRAWINGS

[FIG. 1] FIG. 1 is a schematic view of one embodiment of the present invention.

[FIG. 2] FIG. 2 is a schematic view of a second embodiment of the present invention.

[FIG. 3] FIG. 3 is a view showing a surface distribution after thawing in the embodiments.

[FIG. 4] FIG. 4 is a table of experiment conditions.

[FIG. 5] FIG. 5 is an explanatory view of another embodiment of a sheet member.

[FIG. 6] FIG. 6 is a schematic view of a conventional high-frequency dielectric.

### REFERENCE SIGNS LIST

100 High-frequency dielectric heating device

101 Lower electrode

102 Upper electrode

103 High-frequency power source

110 Sheet member

111 Liquid blocking function layer

112 Liquid passage function layer

113 Liquid absorption function layer

114 Convex portion

115 Concave portion

M Object to be heated

D Drip

### DESCRIPTION OF EMBODIMENTS

The present invention is a high-frequency dielectric heating method in which an object to be heated is disposed between opposing electrodes and is heated, and the specific embodiment of the high-frequency dielectric heating method may be any embodiment as long as a plurality of the objects to be heated are disposed in a direction in which the electrodes oppose each other, and the plurality of the objects to be heated are heated in a state in which the plurality of the objects to be heated are spaced apart by a predetermined distance or more by interposing a sheet member between the plurality of the objects to be heated.

### EXPERIMENTAL EXAMPLE

### (1) Calculation of Dielectric Constant and Result

With regard to the dielectric constant of the sheet member used in Experiment, various sheet members were sandwiched between parallel plate electrodes each having a diameter of 50 mm in an impedance analyzer, the capacitance of each sheet member at a frequency of 10 MHz was measured, and the dielectric constant was calculated from an electrode area and the thickness of the sheet member.

The dielectric constant of each sheet member is as follows.

polyethylene 2.3

foamed polyethylene 1.59

polypropylene nonwoven fabric 1.26

polyester nonwoven fabric 1.24

pulp fiber 1.63

nylon 2.6

### (2) Occurrence/Non-Occurrence Of Drip Outflow

With regard to conditions of the occurrence of drip outflow, a hole was made in a packaging material of a pack of 2 kg of chicken thigh meat in advance such that a drip having occurred during thawing flowed out of the pack.

### (3) Measurement of Surface Temperature

As samples, two packs of 2 kg of chicken thigh meat having a pre-thawing temperature of −20° C. were stacked in two layers, and were heated with a high frequency of 13.56 MHz and an output of 500 VA.

After the heating of 60 minutes, the surfaces of opposing surfaces were imaged by thermography, and temperature distributions and maximum temperatures were measured.

### REFERENCE EXAMPLES 1 to 5

Among embodiments of the present invention, an embodiment that uses a single-layered sheet member is used in each of Reference Examples 1 to 5.

As shown in FIG. 1, a high-frequency dielectric heating device 100 used in the high-frequency dielectric heating method according to one embodiment of the present invention is configured such that a conductive lower electrode 101 and a conductive upper electrode 102 are disposed so as to oppose each other, and an object to be heated M is disposed between the electrodes.

A plurality of the objects to be heated M are disposed so as to be stacked in a direction in which the lower electrode 101 and the upper electrode 102 oppose each other with a sheet member 110 interposed between the plurality of the objects to be heated M, the lower electrode 101 and the upper electrode 102 are connected to a high-frequency power source 103, and the plurality of the objects to be heated M are simultaneously subjected to high-frequency dielectric heating.

In this state, the above-described samples were disposed so as to be stacked in two layers with the sheet member 110 made of polyethylene having a low dielectric constant and a thickness of 0.5 mm or 0.2 mm that is interposed between the samples, the samples were subjected to high-frequency heating, and the surface temperatures of the opposing surfaces were observed. FIG. 4 shows experiment conditions and results.

As a result, as shown in FIGS. 3 and 4, the maximum temperature of the opposing surface of the object to be heated M is controlled to 40° C. or less, and boiling caused by a local significant temperature rise does not occur.

With regard to a thawed state, the chicken thigh meat is thawed to such a degree that pieces of the chicken thigh meat that stuck to each other in the pack when they were frozen can be separated by hand.

As the sheet member 110 is thicker, impedance is increased and a local temperature rise is reduced. However, heating efficiency is reduced, and hence the sheet member 110 is preferably thin moderately.

FIG. 3 shows the surface temperatures of the opposing surfaces after the heating when the same samples as those described above were used and a material having voids was used as the sheet member 110. FIG. 4 shows the experiment conditions and the result.

The dielectric constant is reduced with the presence of the voids in the sheet member 110, and an impedance difference with respect to an air gap can be further reduced. With this, the maximum temperature of the opposing surface of the object to be heated M is controlled to 20° C. or less, and the local significant temperature rise does not occur.

With regard to the thawed state, the chicken thigh meat is thawed to such a degree that pieces of the chicken thigh meat that stuck to each other in the pack when they were frozen can be separated by hand.

It can be seen that, in the case where the sheet member 110 is made of polypropylene (PP) nonwoven fabric having voids, an adequate effect is obtained even when the thickness of the sheet member 110 is 0.1 mm.

Note that, in the case of the sheet member 110 made of foamed polyethylene having a thickness of 6 mm, the heating efficiency was reduced to such a degree that, in the thawed state under the above-described heating condition, pieces of the chicken thigh meat that stuck to each other in the pack when they were frozen could not be separated by hand.

A thawing time from −15° C. to 0° C. in the internal temperature of the object to be heated M in the case of one pack of 2 kg of chicken thigh meat was 54 minutes, and the thawing time was 73 minutes in the case of two packs that were stacked in two layers in Reference Example 4.

Even in the case where it is not possible to arrange the objects to be heated side by side and thaw them due to the heating device or the size of a food material, it becomes possible to thaw the objects to be heated that are stacked in multiple layers without spoiling the quality by interposing the sheet member between the objects to be heated, and it is possible to thaw the objects to be heated in a shorter time than in the case where the objects to be heated are thawed one by one successively.

Maximum ice crystal formation zone (−5° C. to −1° C.) passage times in the case where two packs, four packs, and eight packs of chicken thigh meat, which are stacked in two layers, are heated and thawed under the conditions of Reference Example 4 are 63 minutes, 71 minutes, and 85 minutes, respectively, and can be represented approximately by the following expression.

maximum ice crystal formation zone passage time=3.64×the number of packs+56 [minute]

### EXAMPLE 1

Among embodiments of the present invention, an embodiment that uses a two-layered sheet member is used in Example 1.

Thawing was performed in the same manner as in Reference Example 1 except that a liquid absorption function layer (pulp fiber) and a liquid blocking function layer (foamed PE) were used in this order from the side of the object to be heated M as the sheet member 110 and that the drip was caused to flow out by making a hole in a packaging material, and the surface temperatures were measured. FIGS. 3 and 4 show evaluation results.

The opposing surface maximum temperature is lower than that in Reference Example 5. This is because the liquid absorption function layer absorbs and diffuses the drip, and the drip is thereby prevented from flowing into a concave portion of the object to be heated M and collecting.

### EXAMPLE 2

Among embodiments of the present invention, an embodiment that uses a three-layered sheet member is used in Example 2.

Thawing was performed in the same manner as in Reference Example 1 except that, as shown in FIG. 2, a sheet member 110a formed of three layers—a liquid passage function layer 111, a liquid absorption function layer 112, and a liquid blocking function layer 113—was used, and the surface temperatures were measured.

The sheet member 110a is obtained by stacking polyester nonwoven fabric serving as the liquid passage function layer 111, pulp fiber serving as the liquid absorption function layer 112, and foamed polyethylene having a closed-cell structure that does not allow passage of liquid and serves as the liquid blocking function layer 113. FIG. 4 shows the experiment conditions and the result.

In the case where the object to be heated M is frozen meat or the like, there are cases where the drip occurs during the thawing and, when the drip flows out to the opposing surfaces of the objects to be heated disposed so as to be stacked, the dielectric constant changes according to a wet state, and the local temperature rise becomes more conspicuous.

In the case of the pack of 2 kg of chicken thigh meat used in the above example, the drip does not flow out because the pack is usually packaged, but the package is sometimes broken.

A portion that becomes a contact portion when the objects to be heated M are disposed so as to be stacked is a convex portion, and hence it is highly possible that the package on the convex portion is broken. In the case where the drip flows out, an effect of suppressing the local temperature rise is reduced when only the sheet member 110 of the embodiment described above is used.

In contrast to this, in the case where the sheet member 110a of the present embodiment that includes the three layers is used, as shown in FIGS. 3 and 4, the maximum temperature of the opposing surface of the object to be heated M is controlled to 20° C. or less, and the local significant temperature rise does not occur.

Note that the three layers of the liquid passage function layer, the liquid absorption function layer, and the liquid blocking function layer do not have to be layers made of physically different materials, but only need to be capable of sharing functions.

For example, as shown in FIG. 5, it is also possible to use a sheet member 110b made of a single material that is configured to function as a liquid passage function layer 111b, a liquid absorption function layer 112b, and a liquid blocking function layer 113b by providing a large number of convex portions 114 and concave portions 115 on one of the surfaces of the sheet member 110b such that a drip D having flowed out collects in the bottom portion of the concave portion 115.

While the embodiments of the high-frequency dielectric heating method of the present invention have been described, the present invention is not limited to the above embodiments, and various design changes can be made within the scope of the technical idea of the present invention.

For example, in each of the embodiments described above, the objects to be heated M are stacked in two layers, but the objects to be heated M may also be stacked in three or more layers and the sheet members may be interposed between the opposing surfaces.

In addition, the sheet member may also be interposed between the lower electrode 101 or the upper electrode 102 and the object to be heated M.

Further, the sheet member may be used as a packaging material, and the object to be heated M may be wrapped in the sheet member before being placed between the lower electrode 101 and the upper electrode 102.

### EXAMPLE 3

Three packs of 2 kg of frozen chicken having a pre-thawing temperature of −15° C. were disposed as the objects to be heated between the electrodes in a state in which the packs are stacked in three layers, high-frequency thawing was performed for about 60 minutes with a frequency of 13.56 MHz and an output of 500 VA, and the surface temperature distribution of each of the opposing surfaces of the objects to be heated after the thawing was measured by thermography.

The case where the sheet member made of polyethylene or nylon was disposed between the objects to be heated was compared with the case where the sheet member was not disposed. The area of one of the opposing surfaces of the objects to be heated M was assumed to be 100%, the ratio (hereinafter referred to as an area ratio) of the opposing surface having a surface temperature of not less than 40° C. that influenced the quality in the surface temperature distribution of the opposing surface was calculated using a histogram output function of thermal image analysis software (FSV-S330 produced by Apiste Corporation), and the calculation result is shown in FIG. 4.

As compared with the case where the sheet member was not disposed in Comparative Example, the area ratio of the opposing surface having a temperature of not less than 40° C. was reduced by disposing the polyethylene sheet of Example 3-1.

The area ratio exhibited a further reduction by disposing the nylon sheet having a high dielectric constant of Example 3-2.

### INDUSTRIAL APPLICABILITY

The high-frequency dielectric heating method of the present invention is capable of quickly heating the inside of the object to be heated M while suppressing the local temperature rise on the surface of the object to be heated M and suppressing degradation of quality or taste caused by the temperature rise on the surface of the object to be heated, can be widely applied to thawing of frozen food in restaurants and households and other industrial heating uses, and has high industrial applicability.

1. A high-frequency dielectric heating method in which an object to be heated is disposed between opposing electrodes and is heated, the method comprising:
disposing a plurality of the objects to be heated in a direction in which the electrodes oppose each other; and
heating the plurality of the objects to be heated in a state in which the plurality of the objects to be heated are spaced apart by a predetermined distance or more.

2. The high-frequency dielectric heating method according to claim 1, wherein the plurality of the objects to be heated are spaced apart by the predetermined distance or more by interposing a sheet member between opposing surfaces of the plurality of the objects to be heated.

3. The high-frequency dielectric heating method according to claim 2, wherein the sheet member has a layer having a void inside the layer.

4. The high-frequency dielectric heating method according to claim 2, wherein the sheet member has a liquid blocking function.

5. The high-frequency dielectric heating method according to claim 2, wherein the sheet member has a liquid absorption function.

6. The high-frequency dielectric heating method according to claim 4, wherein the sheet member has at least a liquid absorption function layer and a liquid blocking function layer.

7. The high-frequency dielectric heating method according to claim 6, wherein the sheet member has a liquid passage function layer on a surface on a side of the liquid absorption function layer.

8. The high-frequency dielectric heating method according to claim 4, wherein the liquid blocking function layer in the sheet member does not allow passage of liquid therethrough, and has a cell inside the liquid blocking function layer.

9. The high-frequency dielectric heating method according to claim 2, wherein the sheet member has flexibility.
